(19) United States
(12) Patent Application Publication
(10) Pub. No.: US 2014/0358691 A1
(43) Pub. Date: Dec. 4, 2014

(54) SYSTEM FOR SELECTING AND RECEIVING PRIMARY AND SUPPLEMENTAL ADVERTISER INFORMATION USING A WEARABLE-COMPUTING DEVICE

(71) Applicant: Cloudwear, Inc., Los Angeles, CA (US)

(72) Inventors: Evan Gregory Tann, Manitou Beach, MI (US); Wendell Brown, Henderson, NV (US)

(21) Appl. No.: 14/294,790

(22) Filed: Jun. 3, 2014

Related U.S. Application Data
(60) Provisional application No. 61/830,471, filed on Jun. 3, 2013.

(51) Int. Cl. G06Q 30/02

(52) U.S. Cl. CPC G06Q 30/0241; G06Q 30/0267
USPC 705/14.64; 705/14.4

(57) ABSTRACT

A system for detecting an advertisement is configured to sense a first information associated with the advertisement by a first wearable-computing device, and identify the advertisement from one of a multitude of stored advertisements. The system is further configured to request, in response to a user input, a second information associated with the identified advertisement.

### CROSS-REFERENCES TO RELATED APPLICATIONS

This application claims priority, under 35 USC §119(e), from U.S. Provisional Patent Application No. 61/830,471, entitled “Method and Apparatus for Selecting and Receiving Primary or Supplemental Advertiser Information Using Wearable-Computing Devices,” filed on Jun. 3, 2013, the contents of which is incorporated herein by reference in its entirety. This application is related to the following applications filed herewith: U.S. patent application Ser. No. 14/294,615, titled “METHOD FOR SELECTING AND RECEIVING PRIMARY AND SUPPLEMENTAL ADVERTISER INFORMATION USING A WEARABLE-COMPUTING DEVICE,” U.S. patent application Attorney Docket No. 96643-000130US-910533, titled “METHOD FOR COMMUNICATING PRIMARY AND SUPPLEMENTAL ADVERTISER INFORMATION USING A SERVER,” and U.S. patent application Attorney Docket No. 96643-000140US-910534, titled “SYSTEM FOR COMMUNICATING PRIMARY AND SUPPLEMENTAL ADVERTISER INFORMATION USING A SERVER,” the contents of all of which are incorporated herein by reference in their entirety.

### BACKGROUND OF THE INVENTION

The present invention relates generally to a method and system for receiving ad information, and more specifically to selecting and receiving supplemental information associated with the ad and detected by a wearable-computing device.

An advertisement, hereinafter also referred to as an “ad,” is used to market and sell a product or service. Typical ads contain primary information in the form of images and/or audio information about a product or service. The primary information in the ad may also contain information, such as a toll-free 800 number, a website address, a physical street address, or another means of action that provides a way for the viewer or listener to take an action to either buy the product or obtain more supplemental information related to the ad. Magazine and video ads, roadside billboards, street-level ads, ads on vehicles such as taxis, buses, cars, and the like, contain similar information.

### BRIEF SUMMARY

According to one embodiment of the present invention, a method for detecting an advertisement includes sensing a first information associated with the advertisement by a first wearable-computing device, and identifying the advertisement from one of a multitude of stored advertisements. The method further includes requesting, in response to a user input, a second information associated with the identified advertisement.

According to one embodiment, the method further includes transmitting the requested second information to the first wearable-computing device. According to one embodiment, the method further includes transmitting the requested second information to a personal computing device.

According to one embodiment, the personal computing device is tethered to the first wearable-computing device by wire or wirelessly. According to one embodiment, the personal computing device includes at least one of a smart phone, a portable computing device, a laptop, a mini, a tablet, or a pad.

According to one embodiment, the first wearable-computing device includes a processor and a sensor adapted to sense the first information. According to one embodiment, the first wearable-computing device includes a sensor adapted to be on continuously when the user is wearing the first wearable-computing device.

According to one embodiment, the method further includes detecting a code included in the first information, and identifying the advertisement using the code. According to one embodiment, the first information includes a visual information associated with the advertisement within a line-of-sight of the user when the user is viewing the advertisement. According to one embodiment, the visual information is associated with an image from a camera having a field of view aligned with a line of sight of the user when the user is viewing the advertisement through the first wearable-computing device.

According to one embodiment, the first information includes an audio information associated with the advertisement. According to one embodiment, the audio information is associated with a sound record sensed by a microphone included in the first wearable-computing device. According to one embodiment, the first information includes at least one of an orientation angle, a location, a velocity, or an acceleration associated with the first wearable-computing device. According to one embodiment, the method further includes compressing, using the first wearable-computing device, the first information.

According to one embodiment, the method further includes correlating a location of the first wearable-computing device with a location of one of the multitude of previously stored advertisements. The location of the first wearable-computing device is included in the first information. The method further includes predicting a probable advertisement the first wearable-computing device is likely sensing. A first portion of the advertisement is blocked from being sensed by the first wearable-computing device.

According to one embodiment, the method further includes including the predicted probable advertisement in the second information, and re-creating a virtual advertisement of the predicted probable advertisement on the first wearable-computing device. According to one embodiment, the method further includes including the predicted probable advertisement in the second information, and re-creating a virtual advertisement of the predicted probable advertisement on a personal computing device.

According to one embodiment, correlating further includes correlating a second portion of the advertisement different from the first portion of the advertisement. The second portion of the advertisement is sensed by the first wearable-computing device.

According to one embodiment, correlating further includes correlating an orientation angle associated with the first wearable-computing device. The orientation angle is included in the first information.

According to one embodiment, correlating further includes correlating a third information sensed from a second wearable-computing device different than the first wearable-computing device. The third information was previously sensed by the second wearable-computing device at the location of the first wearable-computing device.

According to one embodiment, identifying includes comparing the first information against characteristics associated with the multitude of previously stored advertisements, and matching the first information to at least one characteristic associated with one of the multitude of previously stored advertisements.

According to one embodiment, the second information is not included in the first information. According to one embodiment, the second information is responsive to the location of the first wearable-computing device.

According to one embodiment, the second information includes an action to be performed associated with the identified advertisement. According to one embodiment, the action to be performed includes purchasing a product associated with the identified advertisement. According to one embodiment, the action to be performed includes purchasing a service associated with the identified advertisement.

According to one embodiment, the action to be performed includes at least one of a request for additional information about a product, an instruction to store the second information, an instruction to transmit the second information, a request to purchase the product, a request to note an interest in the product, a request to put the user on a wish-list for the product, a request for pricing of the product, a request for other transactional information about the product other than pricing of the product, a request to check inventory availability about the product, a request to check competitive sources for the product, or a request to check alternative sources for the product associated with the identified advertisement.

According to one embodiment, the action to be performed includes at least one of a request for additional information about a service, a request to purchase the service, a request to note an interest in the service, a request to put the user on a wish-list for the service, a request for pricing of the service, a request for other transactional information about the service other than pricing of the service, a request to check inventory availability for the service, a request to check competitive sources for the service, or a request to check alternative sources for the service associated with the identified advertisement.

According to one embodiment, the method further includes accepting the user input from the personal computing device. According to one embodiment, the method further includes accepting the user input from the first wearable-computing device.

According to one embodiment, the user input includes at least one of pointing the first wearable-computing device at the advertisement, a voice command, a head motion, a hand motion, a limb motion, a touch input, a button press, or a switch press. According to one embodiment, the user input includes a first portion of the user input being from the personal computing device and a second portion of the user input being from the first wearable-computing device. According to one embodiment, the second portion of the user input includes at least one of pointing the first wearable-computing device at the advertisement, a voice command, a head motion, a hand motion, a limb motion, a touch input, a button press, or a switch press.

According to one embodiment, the method further includes starting an action automatically without the user input after identifying the advertisement. According to one embodiment, the action includes playing an information stream associated with the advertisement.

According to one embodiment, the method further includes sending a third information to a computing device different from the first wearable-computing device. The third information includes at least one of an analytics data, a product, a manufacturer, a retailer, a location of the advertisement, a duration of time the advertisement was viewed, or a time of day the advertisement was viewed. According to one embodiment, the computing device is different from the first wearable-computing device is associated with at least one of an advertisement advertiser, a manufacturer, a retailer, or an interested third party. According to one embodiment, the first wearable-computing device includes a form factor including at least one of an eyeglass, an ear-piece, a wristband, a wrist-device, a medallion, a device worn around the neck, an arm band, an arm-device, a device worn on the head, a piece of clothing, or a piece of outer clothing.

According to one embodiment of the present invention, a system for detecting an advertisement is configured to sense a first information associated with the advertisement by a first wearable-computing device, and identify the advertisement from one of a multitude of stored advertisements. The system is further configured to request, in response to a user input, a second information associated with the identified advertisement.

According to one embodiment, the system is further configured to transmit the requested second information to the first wearable-computing device. According to one embodiment, the system is further configured to transmit the requested second information to a personal computing device.

According to one embodiment, the system is further configured to detect a code included in the first information, and identify the advertisement using the code. According to one embodiment, the system is further configured to compress, using the first wearable-computing device, the first information.

According to one embodiment, the system is further configured to correlate a location of the first wearable-computing device with a location of one of the multitude of previously stored advertisements. The location of the first wearable-computing device is included in the first information. The system is further configured to predict a probable advertisement the first wearable-computing device is likely sensing. A first portion of the advertisement is blocked from being sensed by the first wearable-computing device.

According to one embodiment, the system is further configured to include the predicted probable advertisement in the second information, and re-create a virtual advertisement of the predicted probable advertisement on the first wearable-computing device. According to one embodiment, the system is further configured to include the predicted probable advertisement in the second information, and re-create a virtual advertisement of the predicted probable advertisement on a personal computing device.

According to one embodiment, to correlate further configures the system to correlate a second portion of the advertisement different from the first portion of the advertisement. The second portion of the advertisement is sensed by the first wearable-computing device.

According to one embodiment, to correlate further configures the system to correlate an orientation angle associated with the first wearable-computing device. The orientation angle is included in the first information.

According to one embodiment, to correlate further configures the system to correlate a third information sensed from a second wearable-computing device different than the first wearable-computing device. The third information was previously sensed by the second wearable-computing device at the location of the first wearable-computing device.

According to one embodiment, to identify further configures the system to compare the first information against characteristics associated with the multitude of previously stored advertisements, and match the first information to at least one characteristic associated with one of the multitude of previously stored advertisements. According to one embodiment, the second information is configured to respond to the location of the first wearable-computing device.

According to one embodiment, the system is further configured to accept the user input from the personal computing device. According to one embodiment, the system is further configured to accept the user input from the first wearable-computing device.

According to one embodiment, the user input includes a first portion of the user input being from the personal computing device and a second portion of the user input being from the wearable-computing device. According to one embodiment, the second portion of the user input includes at least one of pointing the wearable-computing device at the advertisement, a voice command, a head motion, a hand motion, a limb motion, a touch input, a button press, or a switch press. According to one embodiment, the system is further configured to start an action automatically without the user input after identifying the advertisement.

According to one embodiment, the system is further configured to send a third information to a computing device different from the first wearable-computing device. The third information includes at least one of an analytics data, a product, a manufacturer, a retailer, a location of the advertisement, a duration of time the advertisement was viewed, or a time of day the advertisement was viewed.

According to one embodiment of the present invention, a method for communicating with a server includes receiving, by the server, a first information associated with an advertisement, and identifying, using the server, the advertisement from one of a multitude of stored advertisements. The method further includes supplying, in response to a request, a second information associated with the identified advertisement.

According to one embodiment, the server receives the first information from a first wearable-computing device. According to one embodiment, the server supplies the second information in response to the request made by a first wearable-computing device. According to one embodiment, the request is associated with a user input.

According to one embodiment, the method further includes transmitting, from the server, the requested second information to a first wearable-computing device. According to one embodiment, the method further includes transmitting, from the server, the requested second information to a personal computing device. According to one embodiment, the method further includes detecting, using the server, a code included in the first information, and identifying, using the server, the advertisement using the code.

According to one embodiment, the first information includes a visual information associated with the advertisement. According to one embodiment, the first information includes at least one of an orientation angle, a location, a velocity, or an acceleration associated with a first wearable-computing device.

According to one embodiment, the method further includes correlating, using the server, a location of a first wearable-computing device with a location of one of the multitude of previously stored advertisements. The location of the first wearable-computing device is included in the first information. The method further includes predicting, using the server, a probable advertisement a first wearable-computing device is likely sensing. A first portion of the advertisement is blocked from being sensed by the first wearable-computing device.

According to one embodiment, the method further includes including, using the server, the predicted probable advertisement in the second information, and re-creating, using the server, a virtual advertisement of the predicted probable advertisement on the first wearable-computing device. According to one embodiment, the method further includes including, using the server, the predicted probable advertisement in the second information, and re-creating, using the server, a virtual advertisement of the predicted probable advertisement on a personal computing device.

According to one embodiment, correlating further includes correlating, using the server, a second portion of the advertisement different from the first portion of the advertisement. The second portion of the advertisement is sensed by the first wearable-computing device.

According to one embodiment, correlating further includes correlating an orientation angle associated with the first wearable-computing device. The orientation angle is included in the first information.

According to one embodiment, correlating further includes correlating a third information sensed from a second wearable-computing device different than the first wearable-computing device. The third information was previously sensed by the second wearable-computing device at the location of the first wearable-computing device.

According to one embodiment, identifying includes comparing, using the server, the first information against characteristics associated with the multitude of previously stored advertisements, and matching, using the server, the first information to at least one characteristic associated with one of the multitude of previously stored advertisements. According to one embodiment, the second information is responsive to the location of a first wearable-computing device.

According to one embodiment, the method further includes accepting, using the server, the request from a personal computing device. According to one embodiment, the method further includes accepting, using the server, the request from a first wearable-computing device.

According to one embodiment, the request includes a first portion of the request being from a personal computing device and a second portion of the request being from a first wearable-computing device.

According to one embodiment, the method further includes starting, using the server, an action automatically without the request after identifying the advertisement. According to one embodiment, the action includes transmitting from the server an information stream associated with the advertisement.

According to one embodiment, the method further includes sending a third information including at least one of an analytics data, a product, a manufacturer, a retailer, a location of the advertisement, a duration of time the advertisement was viewed, or a time of day the advertisement was viewed. According to one embodiment, the third information is sent to a computing device associated with at least one of an advertisement advertiser, a manufacturer, a retailer, or an interested third party.

According to one embodiment of the present invention, a system for communicating with a server is configured to receive, by the server, a first information associated with an advertisement, and identify, using the server, the advertisement from one of a multitude of stored advertisements. The system is further configured to supply, in response to a request, a second information associated with the identified advertisement.

According to one embodiment, the system is further configured to transmit, from the server, the requested second information to a first wearable-computing device. According to one embodiment, the system is further configured to transmit, from the server, the requested second information to a personal computing device. According to one embodiment, the system is further configured to detect, using the server, a code included in the first information, and identify, using the server, the advertisement using the code.

According to one embodiment, the system is further configured to correlate, using the server, a location of a first wearable-computing device with a location of one of the multitude of previously stored advertisements. The location of the first wearable-computing device is included in the first information. The system is further configured to predict, using the server, a probable advertisement a first wearable-computing device is likely sensing. A first portion of the advertisement is blocked from being sensed by the first wearable-computing device.

According to one embodiment, the system is further configured to include, using the server, the predicted probable advertisement in the second information, and re-create, using the server, a virtual advertisement of the predicted probable advertisement on the first wearable-computing device. According to one embodiment, the system is further configured to include, using the server, the predicted probable advertisement in the second information, and re-create, using the server, a virtual advertisement of the predicted probable advertisement on a personal computing device.

According to one embodiment, to correlate further configures the system to correlate, using the server, a second portion of the advertisement different from the first portion of the advertisement. The second portion of the advertisement is sensed by the first wearable-computing device.

According to one embodiment, to correlate further configures the system to correlate an orientation angle associated with the first wearable-computing device. The orientation angle is included in the first information.

According to one embodiment, to correlate further configures the system to correlate a third information sensed from a second wearable-computing device different than the first wearable-computing device. The third information was previously sensed by the second wearable-computing device at the location of the first wearable-computing device.

According to one embodiment, to identify further configures the system to compare, using the server, the first information against characteristics associated with the multitude of previously stored advertisements, and match, using the server, the first information to at least one characteristic associated with one of the multitude of previously stored advertisements.

According to one embodiment, the system is further configured to accept, using the server, the request from a personal computing device. According to one embodiment, the system is further configured to accept, using the server, the request from a first wearable-computing device. According to one embodiment, the system is further configured to start, using the server, an action automatically without the request after identifying the advertisement.

According to one embodiment, the system is further configured to send a third information including at least one of an analytics data, a product, a manufacturer, a retailer, a location of the advertisement, a duration of time the advertisement was viewed, or a time of day the advertisement was viewed. According to one embodiment, the third information is sent to a computing device associated with at least one of an advertisement advertiser, a manufacturer, a retailer, or an interested third party.

A better understanding of the nature and advantages of the embodiments of the present invention may be gained with reference to the following detailed description and the accompanying drawings.

### BRIEF DESCRIPTION OF THE DRAWINGS

FIGS. 1A, 1B, and 1C depict a simplified exemplary block diagram of a networked information system for a wearable-computing device, in accordance with one embodiment of the present invention.

FIG. 1A depicts a simplified exemplary block diagram of a wearable-computing device, in accordance with one embodiment of the present invention.

FIG. 1B depicts a simplified exemplary block diagram of a personal computing device wirelessly tethered to the wearable-computing device represented in FIG. 1A, in accordance with one embodiment of the present invention.

FIG. 1C depicts a simplified exemplary block diagram of a world-wide-web or cloud network linked to the wearable-computing device represented in FIG. 1A, in accordance with one embodiment of the present invention.

FIG. 2 depicts a simplified exemplary block diagram of the wearable-computing device sensing visual ad information, in accordance with one embodiment of the present invention.

FIG. 3 depicts a simplified exemplary block diagram of the wearable-computing device sensing audio ad information, in accordance with one embodiment of the present invention.

FIG. 4 depicts a simplified exemplary flow chart for detecting an advertisement by the wearable-computing device, in accordance with one embodiment of the present invention.

FIG. 5 depicts a simplified block diagram of a computer system that may incorporate embodiments of the present invention.

### DETAILED DESCRIPTION

In accordance with embodiments of the present invention, a wearable-computing device may include any of an eyeglass, an ear-piece, a wristband, a wrist-device, a medallion, a device worn around the neck, an arm band, an arm-device, a device worn on the head such as a hat, a piece of clothing such as a shirt, a pair of pants, a scarf, and the like, a piece of outer clothing such as a coat, jacket, or the like, and other wearable-computing devices, which include a processor and a sensor. Further, the wearable-computing device senses primary information associated with an advertisement by means of visual, audio, near-field communications, infrared, ultrasonic, or other local or line-of-sight techniques. The wearable-computing device recognizes or identifies the ad from one of a multitude of previously stored ads. In response to a user-generated input, the wearable-computing device requests additional supplemental information associated with the identified ad. The request may be for a purchase of the advertised product and/or service or for additional information. The requested information may then be received by the wearable-computing device or a personal computing device associated or tethered to the wearable-computing device.

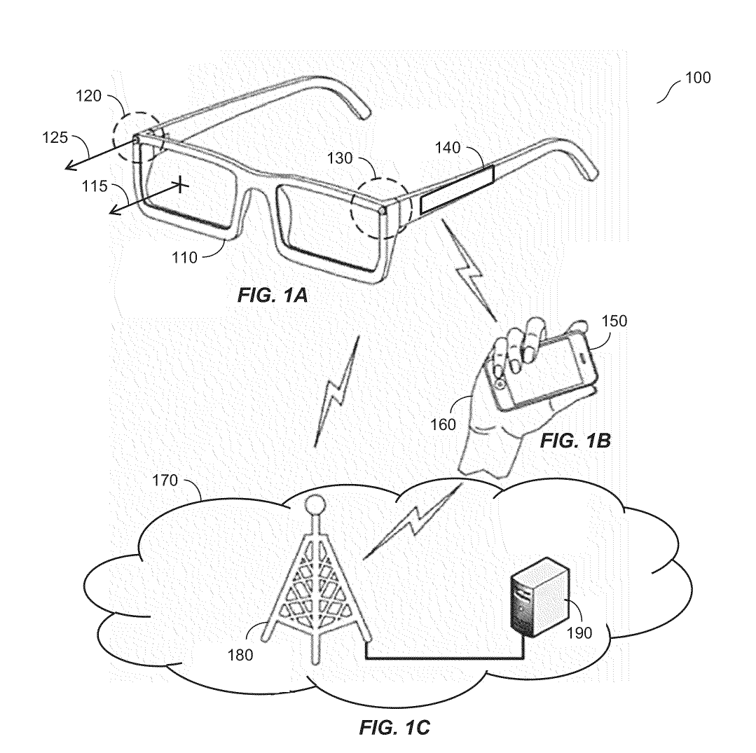

FIGS. 1A, 1B, and 1C depict a simplified exemplary block diagram of a networked information system for a wearable-computing device 100, in accordance with one embodiment of the present invention. FIG. 1A depicts an exemplary simplified block diagram of wearable-computing device 110, in accordance with one embodiment of the present invention. In this example, wearable-computing device 110 includes a form factor for eyewear with one or more displays and may include a sensor such as one or more camera 120, and/or a microphone 130. Camera 120 may include a video and/or a still camera or multiple cameras and one or more optical axis 125 oriented such that the video camera's field of view is aligned with the line of sight of the user 115. In other words, camera 120 may see the same image the user sees through the eyewear of wearable-computing device 110. In one embodiment, the sensor may be on continuously or periodically over a predetermined period of time seeing or hearing whatever the user sees and hears in the vicinity of the user.

Wearable-computing device 110 may further include an electronic circuit 140. Electronic circuit 140 may in-turn include one or more inputs such as a touch sensor or button, a processor, a data store, and a battery. In one embodiment, electronic circuit 140 may include a wireless radio transceiver. In one embodiment, the wireless radio transceiver may operate on low bandwidth, power saving radio transmission standards such as Bluetooth®, 6LoWPAN®, ZigBee®, DASH7®, Z-Wave®, MiWi®, or OSION®. In another embodiment, the wireless radio transceiver may operate using WiFi®, or cellular radio transmission standards. Wearable-computing device 110 may be able to project images received by electronic circuit 140 to the user wearing wearable-computing device 110 through the lenses of the eyewear such that the projected image is seen by the user superimposed over the real image as viewed by the user.

In one embodiment, electronic circuit 140 may further include an audio output device, such as a speaker or bone transducer. In one embodiment, electronic circuit 140 may further include global positioning system (GPS), cellular location, and/or orientation circuitry which may respectively determine the location and/or height on the earth and the orientation at that location of wearable-computing device 110. In other words, orientation circuitry may provide to the wearable-computing device 110 the direction video camera 120 and the user are viewing, for example, compass or azimuth and altitude angles relative to the user. In one embodiment, electronic circuit 140 may further include a gravitational sensor and/or an accelerometer, which may provide a velocity information and/or an acceleration information for the wearable-computing device 110

FIG. 1B depicts a simplified exemplary block diagram of a personal computing device 150 wirelessly tethered to the wearable-computing device represented in FIG. 1A, in accordance with one embodiment of the present invention. FIG. 1B shows an example where personal computing device 150 is a smart phone, however, personal computing device 150 may be any portable computing device such as a laptop, mini, tablet, or pad, which may or may not include a wireless radio transceiver that may link or tether personal computing device 150 to wearable-computing device 100 on user 160. In one embodiment, personal computing device 150 may be tethered to wearable-computing device 110 via a wire and a wired communication system connecting wearable-computing device 110 to personal computing device 150. In one embodiment, location, orientation, gravimetric, and/or acceleration sensors may be included in personal computing device 150 or distributed between wearable-computing device 110 and personal computing device 150 in any combination. Personal computing device 150 may further include a cellular radio transceiver or WiFi® radio transceiver that may link personal computing device 150 to the world-wide-web or cloud network shown in FIG. 1C.

FIG. 1C depicts a simplified exemplary block diagram of a world-wide-web or cloud network 170 linked to wearable-computing device 110 represented in FIG. 1A, in accordance with one embodiment of the present invention. FIG. 1C shows a base station 180 for sending or receiving cellular or WiFi® radio transmission to or from personal computing device 150, respectively. Base station 180 may be coupled to one or more server 190. In one embodiment, a multitude of servers may be located in different locations or in multiple clouds. In another embodiment, wearable-computing device 110 may include a cellular radio transceiver or WiFi® radio transceiver directly providing the link to the world-wide-web or cloud network shown in FIG. 1C without personal computing device 150 serving as the intermediary communications link.

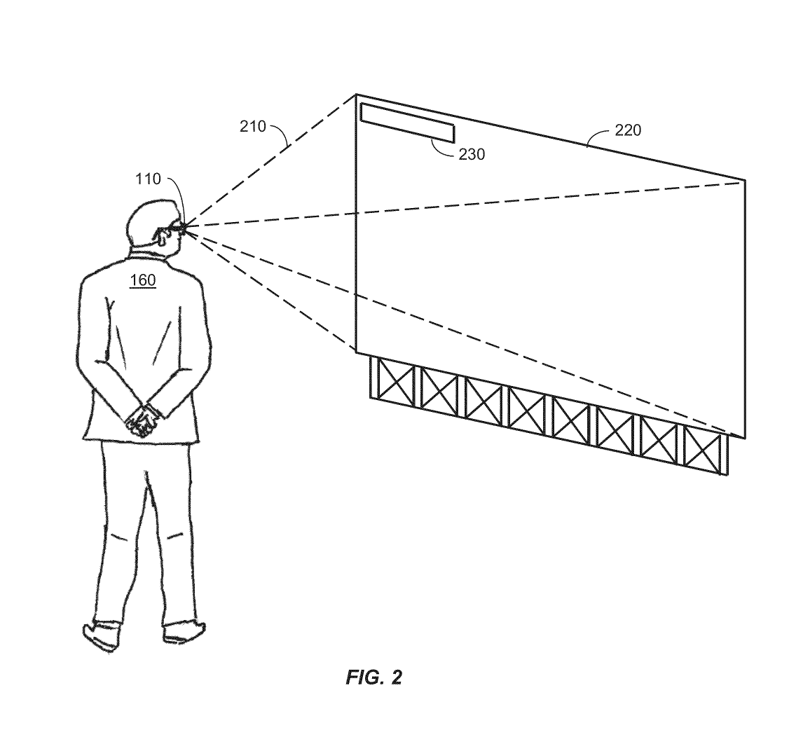

FIG. 2 depicts a simplified exemplary block diagram of wearable-computing device 110 sensing visual ad information 210, in accordance with one embodiment of the present invention. Visual ad information 210 may include; image information from a printed static media and/or a video media ad, a roadside static or video billboard, a page in a magazine or a newspaper or a book, a TV or movie screen, a roadside poster, a street-level ad, an ad on vehicles such as a taxi, a bus, a car, an ad on a computer or laptop or mobile or tablet device in proximity of the user, or any other form of advertisement viewable by the user. The example shown in FIG. 2 shows visual ad information 210 is from a billboard 220. Visual ad information 210 may further include a visual identifier code 230 such as coded text, image, scan code (2D/3D), QR-code, and the like, which can be automatically scanned and detected by wearable-computing device 110 when the user is viewing visual ad information 210.

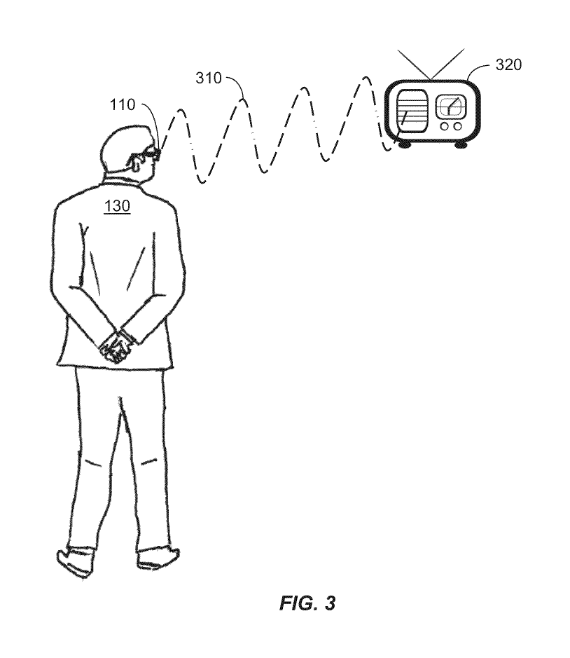

FIG. 3 depicts a simplified exemplary block diagram of wearable-computing device 110 sensing audio ad information 310, in accordance with one embodiment of the present invention. Audio ad information 310 may be from a radio 320, television, or personal computing device 150, and may include automatically identifiable audio identifier code, which may include a music jingle or an audio sequence, such as “call 123-1234.”

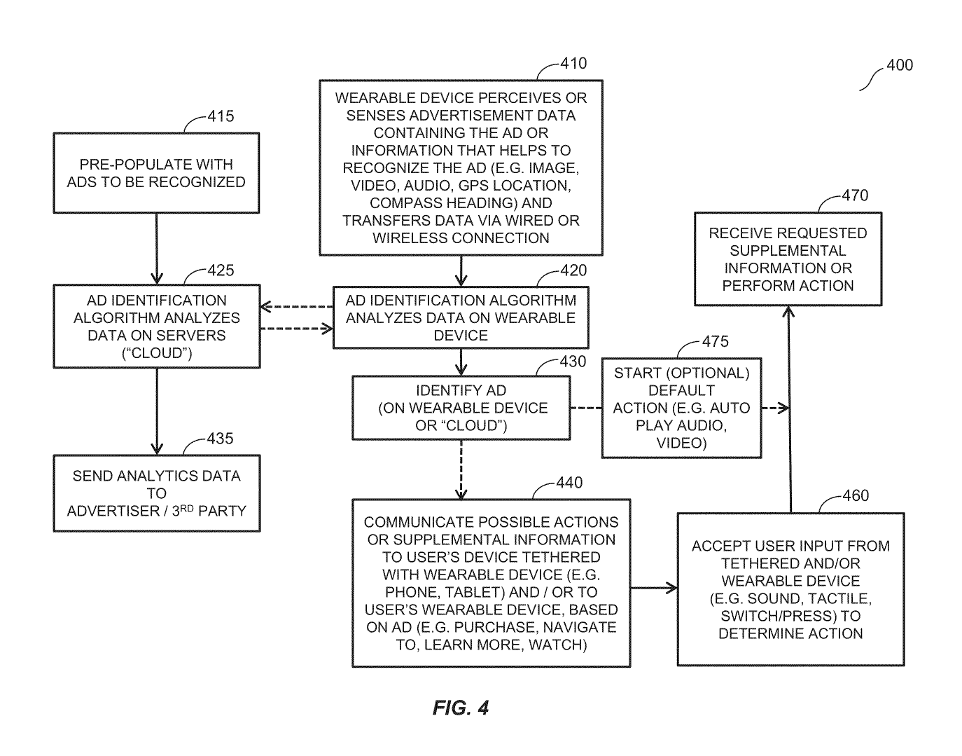

FIG. 4 depicts a simplified exemplary flow chart 400 for detecting an advertisement by the wearable-computing device, in accordance with one embodiment of the present invention. Wearable-computing device 110 perceives or senses 410 primary information from the ad by a sensor in the wearable-computing device. The primary information may include coded data that facilitates identification of the ad, such as for example, visual identifier code 230, referenced in FIG. 2. Referring simultaneously to FIG. 1 and FIG. 4, in one embodiment, the sensor may be video camera 120 and the primary information may be a visual image of the advertisement. In another embodiment, the sensor may be microphone 130 and the primary information may be a sound record from the advertisement. In one embodiment, wearable-computing device 110 senses additional primary information such as GPS location, cell tower code, and/or orientation of wearable-computing device 110, which is tagged or associated with the primary information.

In one embodiment, the primary information from the ad is analyzed 420 by an ad identification algorithm resident in a non-transitory computer readable medium, such as non-volatile memory storing computer-executable code in electronic circuit 140 in wearable-computing device 110. The primary information is compared by the processor in electronic circuit 140 against a pre-populated database including characteristics associated with a multitude of ads in electronic circuit 140. The processor identifies 430 the ad by matching the analyzed primary information to one of the multitude of previously stored or pre-populated ads.

In an alternative embodiment, the primary information from the ad is transferred wirelessly by the wireless radio transceiver in electronic circuit 140 in wearable-computing device 110 or by wire to personal computing device 150, where the ad identification algorithm may be resident in a non-transitory computer readable medium, such as non-volatile memory storing computer-executable code in personal computing device 150. The primary information is analyzed and/or compared by the processor in personal computing device 150 against a pre-populated database including a multitude of ads in personal computing device 150. The processor in personal computing device 150 identifies 430 the ad by matching the analyzed primary information to one of the multitude of previously stored or pre-populated ads in personal computing device 150.

In an alternative embodiment, the primary information from the ad is transferred wirelessly by the wireless radio transceiver in electronic circuit 140 in wearable-computing device 110 or by wire to personal computing device 150, which then wirelessly transfers the primary information from the ad to cloud 170 where the ad identification algorithm may be resident in a non-transitory computer readable medium, such as non-volatile memory storing computer-executable code in server 190. The primary information is analyzed 425 and/or compared by the processor in server 190 against a pre-populated 415 database including a multitude of ads in server 190. The processor in server 190 identifies 430 the ad by matching the analyzed primary information to one of the multitude of previously stored or pre-populated ads in server 190. In one embodiment, the identification processing, such as visual, audio, and the like, done in cloud 170 may be performed by an cloud-based image identification server farm, cloud-based software operating system, or 3^{rd}-party of vendor-party software.

In another alternative embodiment, the primary information from the ad is transferred wirelessly by the wireless radio transceiver in electronic circuit 140 in wearable-computing device 110 or by wire to cloud 170 where the ad identification algorithm may be resident in a non-transitory computer readable medium, such as non-volatile memory storing computer-executable code in server 190. The primary information is compared by the processor in server 190 against pre-populated 415 database including a multitude of ads in server 190. The processor in server 190 identifies 430 the ad by matching the analyzed primary information to one of the multitude of previously stored or pre-populated ads in server 190.

It is understood that, in one embodiment, the ad identification algorithm may consist of a multitude of different portions and the processing of the different algorithm portions may be done in any combination of the processor in wearable-computing device 110, the processor in personal computing device 150, and/or the processor in server 190 to identify 420, 425, 430 the advertisement. For example, the coded data in the visual or audio primary information may be first identified or decoded in an app running in the processor in personal computing device 150. Then, personal computing device 150 sends the decoded version of the coded data associated with the ad to server 190 in cloud 170. In another embodiment, all the ad identification processing may be done by the processor in wearable-computing device 110. In one embodiment, the ad identification processing may be divided or distributed between a multitude of servers in one or more cloud locations and the results of which are then collected by one of the multitude of servers and further analyzed to generate a resulting ad identification output.

It is understood that, in different embodiments, the primary information may or may not contain coded data. If the primary information does not contain coded data, the ad identification algorithm performs the ad identification function without the benefit of coded data, however, the ad identification algorithm may still be done in any combination of the processor in wearable-computing device 110, the processor in personal computing device 150, and/or the processor in server 190.

In one embodiment, the wearable-computing device 110 may transmit the raw primary information to personal computing device 150 or server 190. In another embodiment, the wearable-computing device 110 may compress or reprocess the primary information before transmitting a portion of the primary information or reprocessed primary information to personal computing device 150 or server 190. It is understood that, in different embodiments, the primary information transmitted off wearable-computing device 110 may include all or a portion of static visual data, video data, or audio data, coded portions of such respective data, or compressed portions of such respective data. In one embodiment, wearable-computing device 110 wirelessly transmits a portion of the primary add information to server 190 without personal computing device 150 acting as an intermediary communications relay.

In one embodiment, once the ad is identified, supplemental information, which is information associated with the originally sensed ad but not available or included in the original primary information in the ad may be communicated or transmitted 440 to the user via a computing device including at least one of wearable-computing device 110 or personal computing device 150 tethered to wearable-computing device 110. The supplemental information may have been previously stored in at least one database in wearable-computing device 110, personal computing device 150, and/or server 190. It is understood that the user may receive the supplemental information via any combination of wearable-computing device 110 and/or personal computing device 150 tethered to wearable-computing device 110, via visual, audio, and/or other means. In one embodiment, the supplemental information transmitted 440 to the user may be stored as a log file or user history file in at least one of wearable-computing device 110 or personal computing device 150 tethered to wearable-computing device 110.

For example, supplemental information may be displayed to the user visually through the eyewear embodiment of wearable-computing device 110 and/or may be displayed visually via personal computing device 150 or a combination of both. In another example, supplemental information may be audibly input to the user via wearable-computing device 110 and/or personal computing device 150 or a combination of both. In yet another example, a portion of supplemental information may be audibly input to the user via at least one of wearable-computing device 110 or personal computing device 150, while another portion of supplemental information may be visually input to the user via the other one of wearable-computing device 110 or personal computing device 150.

In accordance with one embodiment of the present invention, once the ad information is identified, a request for information or action to be performed associated with the advertisement may be triggered in response to a user input accepted 460 by a computing device including at least one of wearable-computing device 110 or personal computing device 150 tethered to wearable-computing device 110. Then the requested information may be received or the action may be performed 470 by a computing device including at least one of wearable-computing device 110 or personal computing device 150 tethered to wearable-computing device 110.

In one embodiment, the supplemental information may include at least one user selectable action. In various embodiments, the user selectable action may include any combination of at least; a request for additional information about the ad, an instruction to store or transmit the ad via email or other file transfer means, a request to purchase or note an interest in the product or service, a request to put the user on a wish-list for the product or service, a request for pricing for or other transactional information about the product or service, a request to check local or other inventory or availability information about the product or service, a request to check competitive or alternative sources for the product or service, or otherwise take any other additional action related to the detected product, service, manufacturer, retailer, or other one or more additional similar information presented to the user. In one embodiment, the user is given the user selectable action choices by means of visual display, audio inputs, or other means by at least one of wearable-computing device 110 or personal computing device 150 tethered to wearable-computing device 110.

In one embodiment, the user input may include simply the act of pointing by wearable-computing device 110 at the ad by the user. In another embodiment, the user input may include being selected from any combination of a voice command, a head, hand, or limb motion or gesture, a touch input, a button or switch press, or the like, by the user. In another embodiment, the user input may include being entered and/or collected by or via a related, tethered, paired, or otherwise connected personal computing device 150, i.e. a mobile phone which is paired to the wearable-computing-device via a Bluetooth® connection. Thus, a user can provide inputs to or be detected by wearable-computing-device 110 and/or to the user's mobile phone device or other connected or tethered personal computing device 150.

In one embodiment, once the ad information is identified, a default action may be automatically started 475. In one embodiment, the default action may include playing a video or an audio information stream associated with the advertisement to the user through at least one of wearable-computing device 110 or personal computing device 150 tethered to wearable-computing device 110. For example, as the user turns his head and views the ad for a restaurant, the ad is identified, which may then automatically trigger an action such as playing an audio recording of the restaurant's daily specials without requiring other user input.

In one embodiment, the primary information may include a location information from location sensing devices on wearable-computing device 110 or personal computing device 150 tethered to wearable-computing device 110, which operate in cooperation with GPS, cell phone tower codes, and/or the like location finding services. The location information may be associated with the primary information from the ad and used in conjunction with the primary information.

In one embodiment, a portion of the output of the ad identification algorithm may be stored or indexed into a database in at least one of wearable-computing device 110, personal computing device 150 tethered to wearable-computing device 110, and/or server 190. The output of the ad identification algorithm may include a product, a manufacturer, a retailer, or other one or more additional similar analytics data information. The analytics data may be sent 435 to the ad advertiser, manufacturer, retailer, and/or third party interested in such data. For example, the analytics data may include at least one of a location of the ad, a duration of time the ad was viewed, a time of day the ad was viewed, and/or the like.

In one embodiment, when the location information of the user's computing device is in the primary information, that user's primary information may then be cross-correlated with another user's primary information as seen or heard from that similar location. In one embodiment, the cross-correlated data may be used to improve the speed and/or accuracy of the supplemental information sent to the user's computing device at that location. In one embodiment, the cross-correlated data may be used to modify the supplemental information sent to the user at that location. In one embodiment, the supplemental information sent to the user may be responsive to the location information.

In one embodiment, when the location information of the user and the orientation information from wearable-computing device 110, i.e. the user's head direction altitude and compass heading, velocity, and/or acceleration, are in the primary information, the location and orientation information may be correlated with an associated one of the plurality of previously stored advertisements to predict a probable ad the user is likely viewing, and/or hearing. In another embodiment, the location information of the user, the orientation information from wearable-computing device 110, and the camera or microphone sensor's real partial input of the advertisement, are correlated to detect which advertisement the user should probably be seeing or hearing. For example, during a low-light situation or when another object, such as a tree or truck, might be blocking the user's actual view of the ad, i.e. blocked from being sensed by the wearable-computing device, the probable ad is identified instead.

In one embodiment, when the location information of the user and the orientation information from wearable-computing device 110 are in the primary information, the location and orientation information and, optionally, the camera or microphone sensor's real partial input of the ad, may be correlated to predict a probable ad the user is likely viewing, and/or hearing. The probable ad is then transmitted in the supplemental information to the at least one of wearable-computing device 110 or personal computing device 150 tethered to wearable-computing device 110. The at least one of wearable-computing device 110 or personal computing device 150 tethered to wearable-computing device 110 then may re-create the ad for the user or create a simulated view, e.g. a virtual view, or sound to be seen/heard by the user of the probable advertisement the user should be seeing or hearing. In one embodiment, primary or supplemental information may be modified by time of day, day of the week, user's preferences, user's detected preferences, user's prior activities, or other similar information or variables.

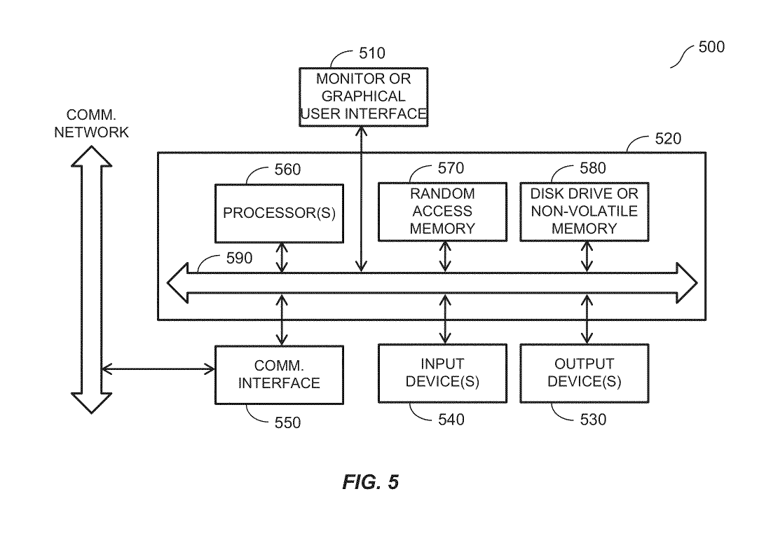

FIG. 5 depicts a simplified block diagram of a computer system that may incorporate embodiments of the present invention. FIG. 5 is merely illustrative of an embodiment incorporating the present invention and does not limit the scope of the invention as recited in the claims. One of ordinary skill in the art would recognize other variations, modifications, and alternatives.

In one embodiment, computer system 500 typically includes a monitor or display 510, a computer 520, user output devices 530, user input devices 540, communications interface 550, and the like. Computer system 500 may also be a smart phone, tablet-computing device, and the like, such that the boundary of computer 520 may enclose monitor or graphical user interface 510, user output devices 530, user input devices 540, and/or communications interface 550 (not shown).

As depicted in FIG. 5, computer 520 may include a processor(s) 560 that communicates with a number of peripheral devices via a bus subsystem 590. These peripheral devices may include user output devices 530, user input devices 540, communications interface 550, and a storage subsystem, such as random access memory (RAM) 570 and disk drive or non-volatile memory 580.

User input devices 530 include all possible types of devices and mechanisms for inputting information to computer system 520. These may include a keyboard, a keypad, a touch screen incorporated into the display, audio input devices such as voice recognition systems, microphones, and other types of input devices. In various embodiments, user input devices 530 are typically embodied as a computer mouse, a trackball, a track pad, a joystick, wireless remote, drawing tablet, voice command system, eye tracking system, and the like. User input devices 530 typically allow a user to select objects, icons, text and the like that appear on the monitor or graphical user interface 510 via a command such as a click of a button, touch of the display screen, or the like.

User output devices 540 include all possible types of devices and mechanisms for outputting information from computer 520. These may include a display (e.g., monitor or graphical user interface 510), non-visual displays such as audio output devices, etc.

Communications interface 550 provides an interface to other communication networks and devices. Communications interface 550 may serve as an interface for receiving data from and transmitting data to other systems. Embodiments of communications interface 550 typically include an Ethernet card, a modem (telephone, satellite, cable, ISDN), (asynchronous) digital subscriber line (DSL) unit, FireWire interface, USB interface, and the like. For example, communications interface 550 may be coupled to a computer network, to a FireWire bus, or the like. In other embodiments, communications interfaces 550 may be physically integrated on the motherboard of computer 520, and may be a software program, such as soft DSL, or the like. Embodiments of communications interface 550 may also include a wireless radio transceiver using radio transmission protocols such as Bluetooth®, WiFi®, cellular, and the like.

In various embodiments, computer system 500 may also include software that enables communications over a network such as the HTTP, TCP/IP, RTP/RTSP protocols, and the like. In alternative embodiments of the present invention, other communications software and transfer protocols may also be used, for example IPX, UDP or the like.

In some embodiment, computer 520 includes one or more Xeon microprocessors from Intel as processor(s) 560. Further, one embodiment, computer 520 includes a UNIX-based operating system. In another embodiment, the processor may be included in an applications processor or part of a system on a chip.

RAM 570 and disk drive or non-volatile memory 580 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like. RAM 570 and disk drive or non-volatile memory 580 may be configured to store the basic programming and data constructs that provide the functionality of the present invention.

Software code modules and instructions that provide the functionality of the present invention may be stored in RAM 570 and disk drive or non-volatile memory 580. These software modules may be executed by processor(s) 560. RAM 570 and disk drive or non-volatile memory 580 may also provide a repository for storing data used in accordance with the present invention.

RAM 570 and disk drive or non-volatile memory 580 may include a number of memories including a main random access memory (RAM) for storage of instructions and data during program execution and a read only memory (ROM) in which fixed instructions are stored. RAM 570 and disk drive or non-volatile memory 580 may include a file storage subsystem providing persistent (non-volatile) storage for program and data files. RAM 570 and disk drive or non-volatile memory 580 may also include removable storage systems, such as removable flash memory.

Bus subsystem 590 provides a mechanism for letting the various components and subsystems of computer 520 communicate with each other as intended. Although bus subsystem 590 is shown schematically as a single bus, alternative embodiments of the bus subsystem may utilize multiple busses.

FIG. 5 is representative of a computer system capable of embodying a portion of the present invention. It will be readily apparent to one of ordinary skill in the art that many other hardware and software configurations are suitable for use with the present invention. For example, the computer may be a desktop, laptop, portable, rack-mounted, smart phone or tablet configuration. Additionally, the computer may be a series of networked computers. Further, the use of other microprocessors are contemplated, such as Pentium™ or Itanium™ microprocessors; Opteron™ or AthlonXP™ microprocessors from Advanced Micro Devices, Inc; embedded processors such as ARM® licensed from ARM® Holdings plc., and the like. Further, other types of operating systems are contemplated, such as Windows®, WindowsXP®, WindowsNT®, WindowsRT®, Windows Embedded Automotive® or the like from Microsoft Corporation, Solaris from Sun Microsystems, LINUX, UNIX, or mobile operating systems such as Android® from Google Inc., iOS® from Apple Inc., Symbion® from Nokia Corp., and the like. In still other embodiments, the techniques described above may be implemented upon a chip or an auxiliary processing board.

Various embodiments of the present invention can be implemented in the form of logic in software or hardware or a combination of both. The logic may be stored in a computer readable or machine-readable non-transitory storage medium as a set of instructions adapted to direct a processor of a computer system to perform a set of steps disclosed in embodiments of the present invention. The logic may form part of a computer program product adapted to direct an information-processing device to perform a set of steps disclosed in embodiments of the present invention. Based on the disclosure and teachings provided herein, a person of ordinary skill in the art will appreciate other ways and/or methods to implement the present invention.

The above embodiments of the present invention are illustrative and not limiting. The above embodiments of the present invention may be combined, in one or multiple combinations, as various alternatives and equivalents are possible. Although, the invention has been described with reference to a wearable-computing device such as smart-glasses by way of an example, it is understood that the invention is not limited by the type of wearable device. Although, the invention has been described with reference to certain radio communications interface by way of an example, it is understood that the invention is not limited by the type of radio, wireless, or wired communications interface. Although, the invention has been described with reference to certain operating systems by way of an example, it is understood that the invention is not limited by the type of operating systems. Other additions, subtractions, or modifications are obvious in view of the present disclosure and are intended to fall within the scope of the appended claims.

What is claimed is:

1. A system for detecting an advertisement configured to:
sense a first information associated with the advertisement by a first wearable-computing device;
identify the advertisement from one of a plurality of stored advertisements; and
request, in response to a user input, a second information associated with the identified advertisement.

2. The system of claim 1 further configured to:
transmit the requested second information to the first wearable-computing device.

3. The system of claim 1 further configured to:
transmit the requested second information to a personal computing device.

4. The system of claim 1, wherein the personal computing device is tethered to the first wearable-computing device by wire or wirelessly.

5. The system of claim 1, wherein the personal computing device comprises at least one of a smart phone, a portable computing device, a laptop, a mini, a tablet, or a pad.

6. The system of claim 1, wherein the first wearable-computing device includes a processor and a sensor adapted to sense the first information.

7. The system of claim 1, wherein the first wearable-computing device includes a sensor adapted to be on continuously when the user is wearing the first wearable-computing device.

8. The system of claim 1 further configured to:
detect a code included in the first information; and
identify the advertisement using the code.

9. The system of claim 1, wherein the first information includes a visual information associated with the advertisement within a line-of-sight of the user when the user is viewing the advertisement.

10. The system of claim 9, wherein the visual information is associated with an image from a camera having a field of view aligned with a line of sight of the user when the user is viewing the advertisement through the first wearable-computing device.

11. The system of claim 1, wherein the first information includes an audio information associated with the advertisement.

12. The system of claim 11, wherein the audio information is associated with a sound record sensed by a microphone included in the first wearable-computing device.

13. The system of claim 1, wherein the first information comprises at least one of an orientation angle, a location, a velocity, or an acceleration associated with the first wearable-computing device.

14. The system of claim 1 further configured to:
compress, using the first wearable-computing device, the first information.

15. The system of claim 1 further configured to:
correlate a location of the first wearable-computing device with a location of one of the plurality of previously stored advertisements, wherein the location of the first wearable-computing device is included in the first information; and
predict a probable advertisement the first wearable-computing device is likely sensing, wherein a first portion of the advertisement is blocked from being sensed by the first wearable-computing device.

16. The system of claim 15 further configured to:
include the predicted probable advertisement in the second information; and
re-create a virtual advertisement of the predicted probable advertisement on the first wearable-computing device.

17. The system of claim 15 further configured to:
include the predicted probable advertisement in the second information; and
re-create a virtual advertisement of the predicted probable advertisement on a personal computing device.

18. The system of claim 15, wherein to correlate further configures the system to correlate a second portion of the advertisement different from the first portion of the advertisement, wherein the second portion of the advertisement is sensed by the first wearable-computing device.

19. The system of claim 15, wherein to correlate further configures the system to correlate an orientation angle associated with the first wearable-computing device, wherein the orientation angle is included in the first information.

20. The system of claim 15, wherein to correlate further configures the system to correlate a third information sensed from a second wearable-computing device different than the first wearable-computing device, wherein the third information was previously sensed by the second wearable-computing device at the location of the first wearable-computing device.

21. The system of claim 1, wherein to identify further configures the system to:
compare the first information against characteristics associated with the plurality of previously stored advertisements; and
match the first information to at least one characteristic associated with one of the plurality of previously stored advertisements.

22. The system of claim 1, wherein the second information is not included in the first information.

23. The system of claim 1, wherein the second information is configured to respond to the location of the first wearable-computing device.

24. The system of claim 1, wherein the second information includes an action to be performed associated with the identified advertisement.

25. The system of claim 24, wherein the action to be performed includes purchasing a product associated with the identified advertisement.

26. The system of claim 24, wherein the action to be performed includes purchasing a service associated with the identified advertisement

27. The system of claim 24, wherein the action to be performed comprises at least one of a request for additional information about a product, an instruction to store the second information, an instruction to transmit the second information, a request to purchase the product, a request to note an interest in the product, a request to put the user on a wish-list for the product, a request for pricing of the product, a request for other transactional information about the product other than pricing of the product, a request to check inventory availability about the product, a request to check competitive sources for the product, or a request to check alternative sources for the product associated with the identified advertisement.

28. The system of claim 24, wherein the action to be performed comprises at least one of a request for additional information about a service, a request to purchase the service, a request to note an interest in the service, a request to put the user on a wish-list for the service, a request for pricing of the service, a request for other transactional information about the service other than pricing of the service, a request to check inventory availability for the service, a request to check competitive sources for the service, or a request to check alternative sources for the service associated with the identified advertisement.

29. The system of claim 1 further configured to:
accept the user input from the personal computing device.

30. The system of claim 1 further configured to:
accept the user input from the first wearable-computing device.

31. The system of claim 1, wherein the user input comprises at least one of pointing the first wearable-computing device at the advertisement, a voice command, a head motion, a hand motion, a limb motion, a touch input, a button press, or a switch press.

32. The system of claim 1, wherein the user input includes a first portion of the user input being from the personal computing device and a second portion of the user input being from the wearable-computing device.

33. The system of claim 32, wherein the second portion of the user input comprises at least one of pointing the wearable-computing device at the advertisement, a voice command, a head motion, a hand motion, a limb motion, a touch input, a button press, or a switch press.

34. The system of claim 1 further configured to:
start an action automatically without the user input after identifying the advertisement.

35. The system of claim 34, wherein the action includes playing an information stream associated with the advertisement.

36. The system of claim 1 further configured to:
send a third information to a computing device different from the first wearable-computing device, wherein the third information comprises at least one of an analytics data, a product, a manufacturer, a retailer, a location of the advertisement, a duration of time the advertisement was viewed, or a time of day the advertisement was viewed.

37. The system of claim 36, wherein the computing device is different from the first wearable-computing device is associated with at least one of an advertisement advertiser, a manufacturer, a retailer, or an interested third party.

38. The system of claim 1, wherein the first wearable-computing device includes a form factor comprising at least one of an eyeglass, an ear-piece, a wristband, a wrist-device, a medallion, a device worn around the neck, an arm band, an arm-device, a device worn on the head, a piece of clothing, or a piece of outer clothing.
